(19) United States
(12) Patent Application Publication
(10) Pub. No.: US 2012/0291641 A1
(43) Pub. Date: Nov. 22, 2012

(54) DEVICE FOR BEARING ONE OR MORE CYLINDERS OF A PRINTING PRESS

(75) Inventor: Manfred Herrmann Liebler, Erlenbach (DE)

(73) Assignee: KOENIG & BAUER AKTIENGESELLSCHAFT, Wurzburg (DE)

(21) Appl. No.: 13/519,337

(22) PCT Filed: Oct. 11, 2010
(86) PCT No.: PCT/EP10/65168

§ 371 Date: Jun. 27, 2012

(30) Foreign Application Priority Data
Jan. 14, 2010 (DE) 10 2010 000 891.5
Jun. 22, 2010 (DE) 10 2010 030 331.3

(51) Int. Cl. B41F 5/00

(52) U.S. Cl. 101/216

(57) ABSTRACT

A cylinder of a printing press is supported by bearings in side frames of the printing press. An inner ring of a radial bearing serves a journal of the cylinder which is arranged directly over a bearing agent in an outer ring thus enabling a radial movement of the journal. The outer ring is mounted, either directly or indirectly in an opening of the side frame. The radial bearing is arranged in a region of the outer ring, as viewed in an axial direction of the cylinder, which protrudes out of a frame alignment of the side frame toward the side of the cylinder. The bearing agent which enables radial movement of the cylinder is also arranged in a region of the outer ring protruding out of the frame alignment of the side frame toward the side of the cylinder.

The invention relates to devices for mounting one or more cylinders of a printing press according to the preamble of claim 1 and/or 6.

From EP 1 923 214 A2 a printing unit is known, in which forme and transfer cylinders are mounted at least in pairs in a shared cartridge, which can in turn be installed in an opening in the side frame configured for this purpose. In this case the transfer cylinder is mounted in a radial bearing, which is arranged in an eccentric bearing so as to enable a throw on/throw off movement. The bearing assembly of radial bearing and eccentric bearing is provided in an area of the cartridge which projects out of a frame alignment of the side frame toward the side of the cylinder.

EP 1 990 192 A2 discloses a mounting of a cylinder of a rotary printing press, wherein in one embodiment, to avoid thermally induced stresses, the radial bearing that accommodates a cylinder journal is provided in an area of the bearing which projects out of a frame alignment of the side frame toward the side of the cylinder. In this case, an eccentric bearing that enables a throw on/throw off movement is not intended to intersect with the radial bearing in an axial direction, and is arranged in the frame alignment.

EP 1 232 062 B1 also discloses a radial bearing which accommodates a cylinder journal and which is provided eccentrically in an area of a bearing sleeve arranged in the frame and projecting out of a frame alignment of the side frame toward the side of the cylinder.

DD 55 482 A1 relates to a clamping attachment of a roller bearing in a housing. The roller bearing is to be securely fastened in the housing by clamping, wherein tolerance measurements in the housing bore and external dimensions are to be bridged. For this purpose, the roller bearing or the outer ring thereof is clamped by cotters arranged between housing and bearing outer ring. In this, the cotter-shaped sections are located at the level of the frame and at the level of the roller bearing.

From DE 10 2007 001 920 A1, a roller bearing device for spindles, particularly motor spindles, is known, wherein the bearing outer rings of two axially spaced radial bearings are supported in a sleeve. The bearing outer ring of one of the two bearings is supported in the sleeve via a spring-loaded cotter connection. The roller bearings are therefore operated under radial preload.

DE 10 2007 001 918 A1 relates to a roller bearing operated with radial preload, wherein the outer ring is supported in a housing via a spring-loaded cotter connection.

DE 10 2008 000 204 A1 discloses various concepts for mounting a printing couple cylinder of a printing press, which are intended to reduce the risk of bearing damage resulting from the heating of the bearings. Among other things, it discloses in one embodiment a device for mounting a cylinder in a side frame, wherein an inner ring of a radial bearing is provided for accommodating a journal of the cylinder, which is mounted in a spacer ring, which is in turn mounted in an exterior ring via rolling elements. To enable a print on/print off positioning movement, the inner ring is arranged eccentrically in relation to the periphery of the spacer ring. To allow the radial bearing to expand unimpeded when heated, it is arranged in a region of the spacer ring which projects out of a frame alignment of the side frame toward the side of the cylinder. To this end, the support between outer ring and spacer ring is arranged axially offset in the frame alignment, so that the radial bearing can expand when heated without being constrained by the outer ring.

The problem addressed by the invention is that of providing devices for mounting one or more cylinders of a printing press.

The problem is solved according to the invention by the features of claim 1 and/or 6.

The advantages to be achieved by the invention consist particularly in that a bearing is provided which has the lowest possible amount of play, but is also wear resistant and highly rigid.

This bearing can be produced in a simple manner, and enables a proper alignment of interacting printing couple cylinders.

Shifting the radial bearing out of the active clamping area in the frame, particularly out of the alignment of the frame in which the bearing device is clamped, enables play-free, highly powerful clamping without the effect of harmful bearing forces.

In the case of a bearing that is pivotable with respect to its rotational axis, for example, in combination with a support of a cylinder that is to be mounted so as to be movable in terms of a possibility for throw on/throw off adjustment, it is advantageous to also provide the arrangement of a corresponding pivot bearing, particularly an eccentric device, in an area outside of the frame alignment—particularly on the side close to the cylinder. The axial positions of pivot bearing and radial bearing are preferably chosen such that the support areas thereof at least intersect the same plane, which is perpendicular to the axis.

All of this enables a rigid clamping of a bearing housing (e.g., of an outer bearing ring) in a frame wall, without placing an undue load on the bearing means of the eccentric device. Moreover, potential tilting moments which could potentially cause an axial displacement of radial and pivot bearings are avoided.

For the embodiment in which at least the radial bearing that rotatably accommodates the journal is provided in the area outside of the frame alignment toward the cylinder, in a further development the entire bearing assembly can be mounted in the frame by clamping the bearing assembly in bore holes of the frame using a device configured as a set of clamping rings. In this case, clamping can be accomplished without adjusting bearing clearance and/or bearing tension. Furthermore, if an additional bearing for implementing correcting movements is provided, said bearing can also be arranged outside of the frame alignment.

Embodiment examples of the invention are illustrated in the set of drawings and will be specified in greater detail in what follows.

The drawings show:

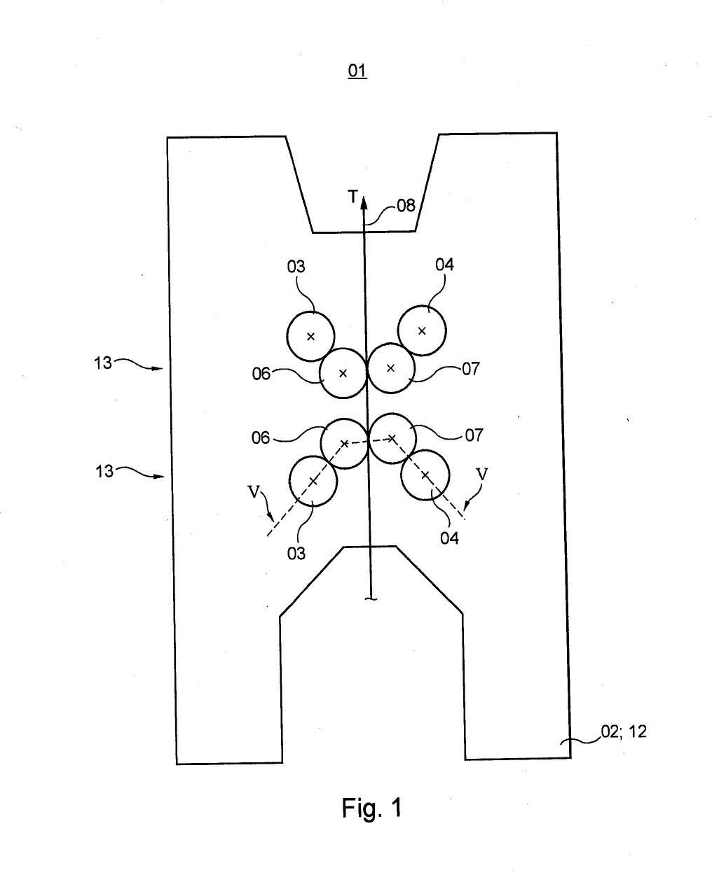

FIG. 1 a schematic illustration of a printing unit;

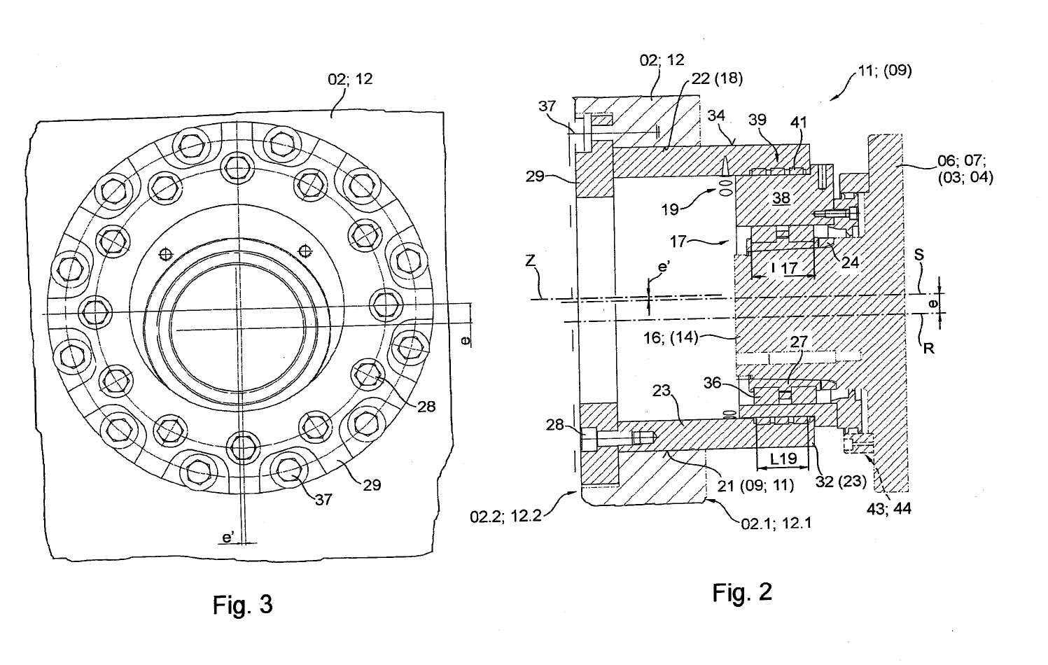

FIG. 2 a cross-section of a bearing device with eccentric bearing;

FIG. 3 a side view of a bearing device arranged in the side frame with concealed edges as indicated in FIG. 2;

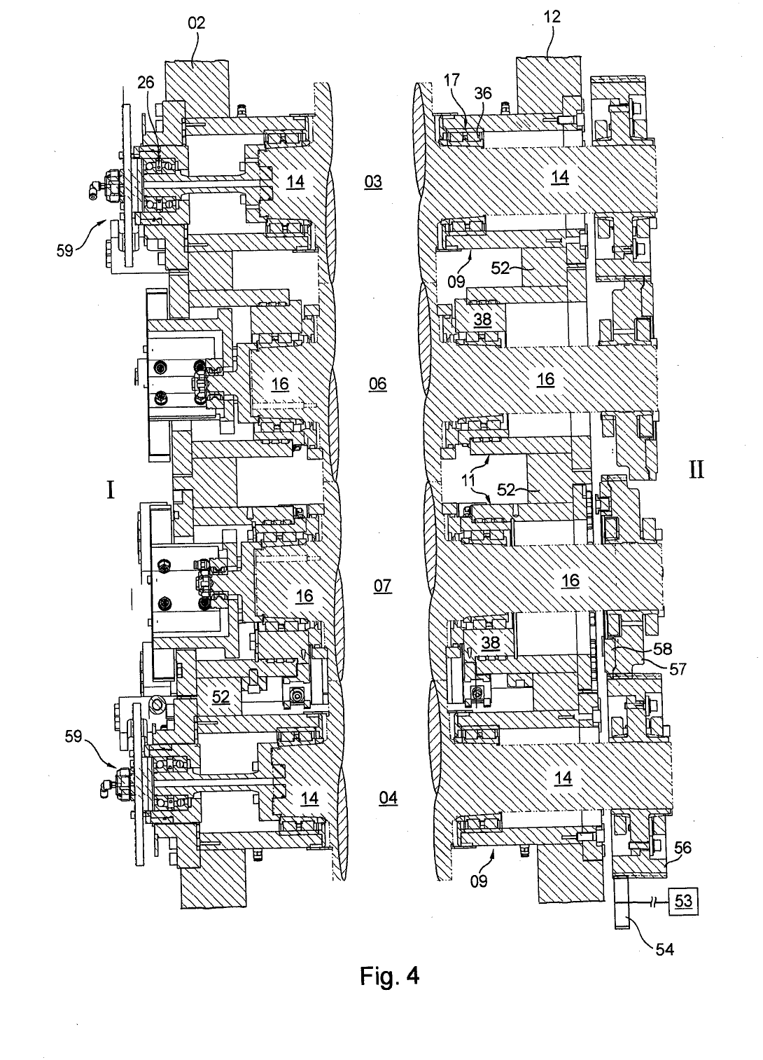

FIG. 4 a section through the bearing of a blanket-to-blanket printing couple, along a line of cut V-V indicated in FIG. 1;

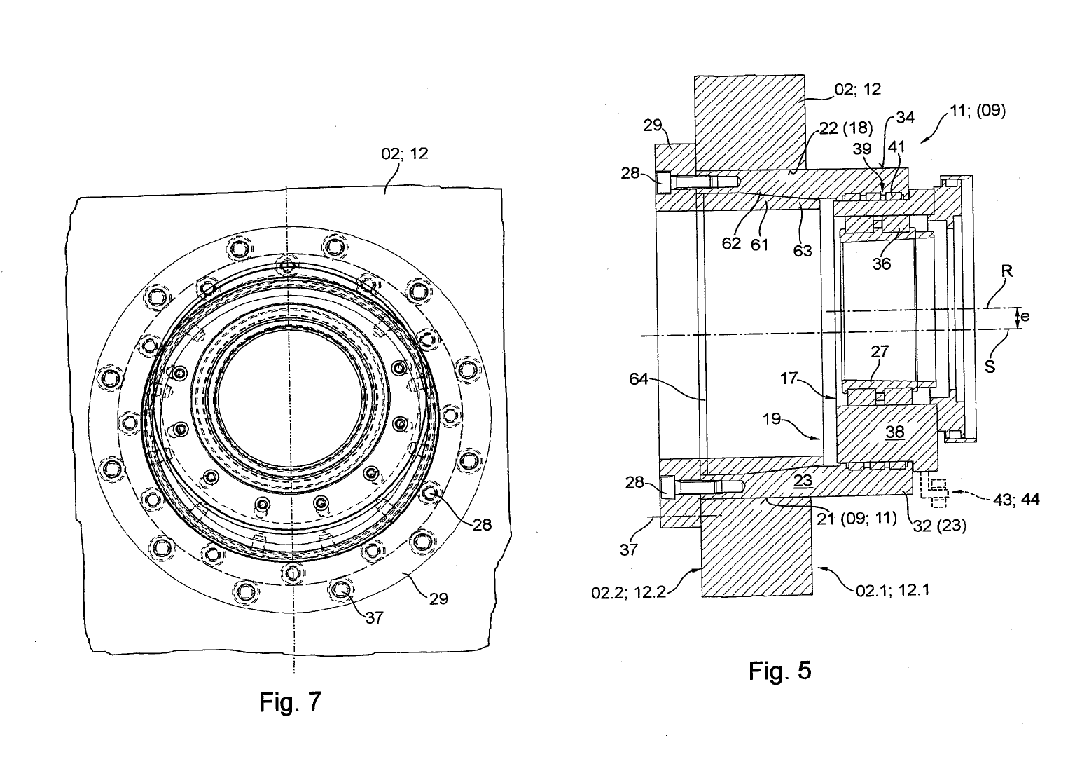

FIG. 5 a cross-section of a bearing device with eccentric bearing in a second embodiment;

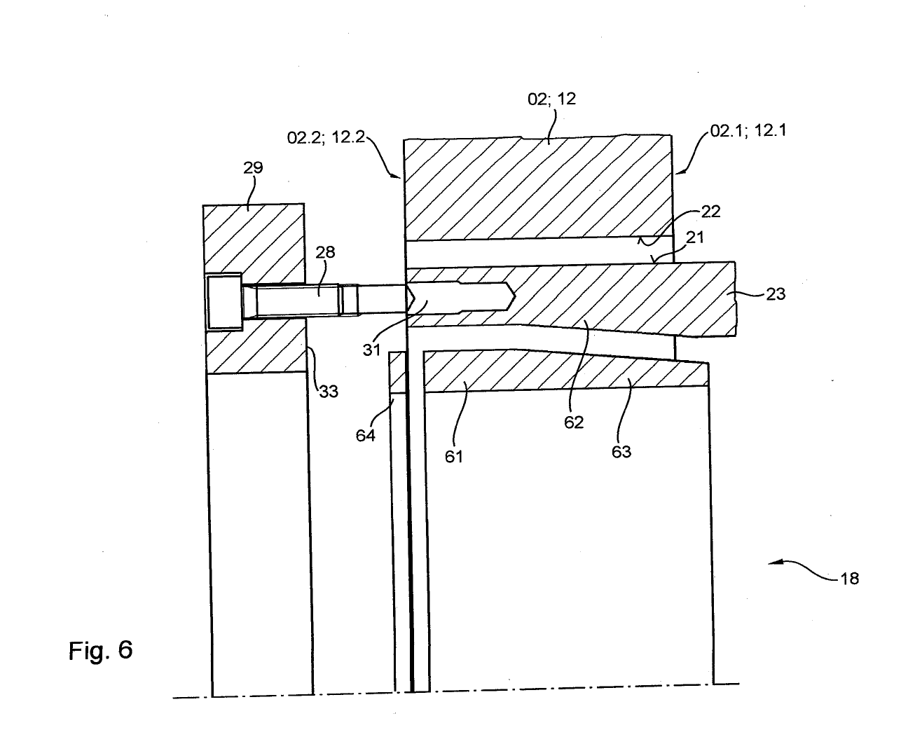

FIG. 6 an exploded, detailed view of FIG. 5;

FIG. 7 a side view of a bearing device, arranged in the side frame, in a second embodiment with concealed edges as indicated in FIG. 5;

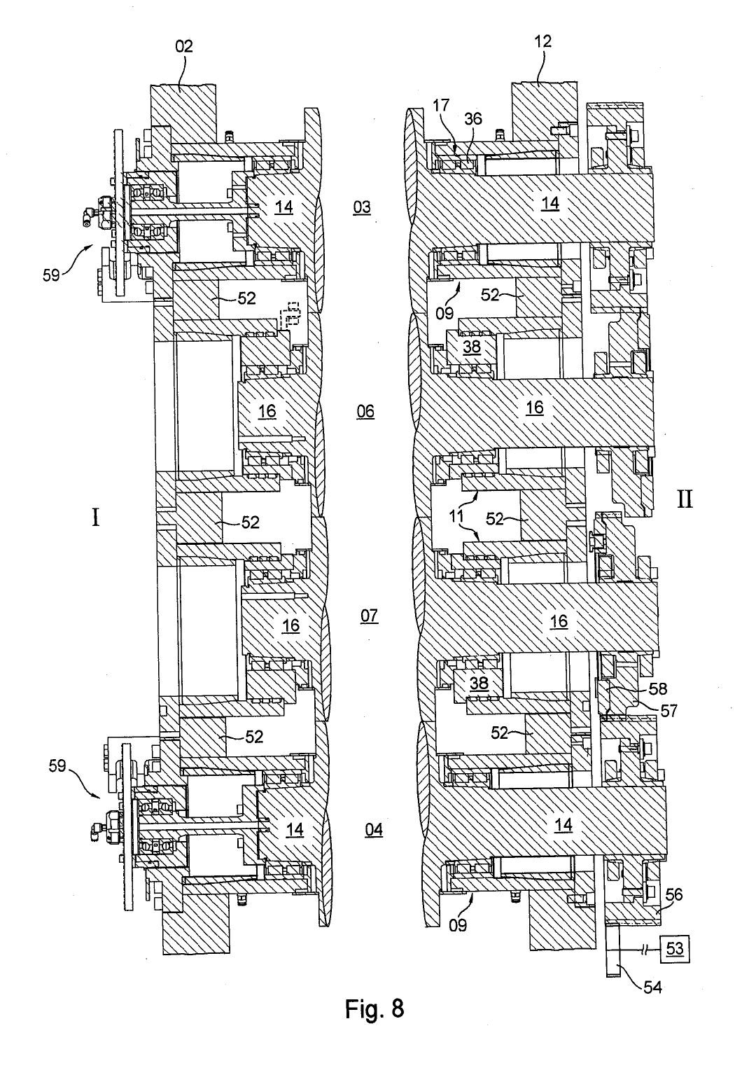

FIG. 8 a section through the bearing of a blanket-to-blanket printing couple in a second embodiment, along a line of cut V-V indicated in FIG. 1;

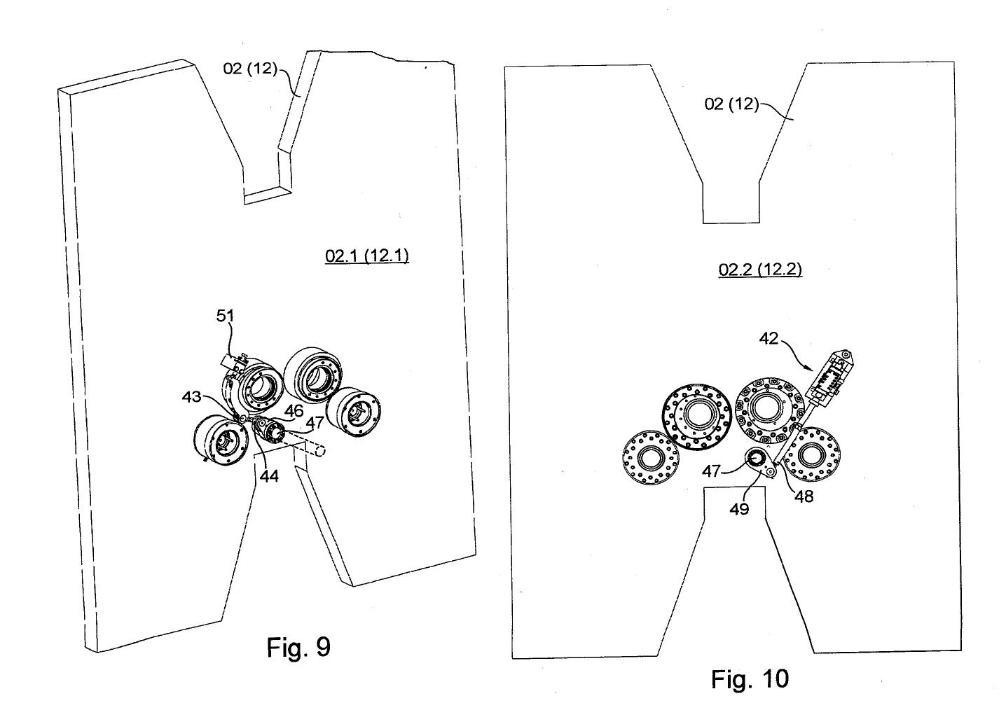

FIG. 9 an interior view of the bearing devices of the blanket-to-blanket printing couple with adjustment means, illustrated by way of example for one of the transfer cylinders;

FIG. 10 an exterior view of the bearing devices of the blanket-to-blanket printing couple with an adjustment drive, illustrated by way of example for one of the transfer cylinders.

In a printing unit 01 of a printing press, for example, a web-fed rotary printing press, more particularly, a web-fed rotary offset printing press, the remainder of which is not illustrated in greater detail here, cylinders 03; 04; 06; 07, more particularly, printing couple cylinders 03; 04; 06; 07, are supported in bearing devices 09; 11 in end face side frames 02; 12 of the printing press, and are mounted so as to be rotatable about their respective axes.

In the case of the embodiment example, cylinders 03; 04 are embodied as forme cylinders 03; 04 and cylinders 06; 07 are embodied as transfer cylinders 06; 07 of a blanket-to-blanket printing couple 13. The blanket-to-blanket printing couple 13 can be embodied in a planar configuration, i.e., with the rotational axes of the four cylinders 03; 04; 06; 07 arranged in a shared plane in the print-on position, as an n-type printing couple, as in the lower blanket-to-blanket printing couple 13 identified by 13, or as a u-type printing couple, as in the upper blanket-to-blanket printing couple 13. The printing unit 01 can have a plurality of blanket-to-blanket printing couples 13, particularly two blanket-to-blanket printing couples 13. In the case of the embodiment example, the printing couple cylinders 03; 04; 06; 07 are arranged in an approximately u-shaped and an approximately n-shaped constellation for the purpose of forming an arch-type printing unit 13 in each case, wherein the two arch-type printing units 13 are arranged one above the other and together define a so-called H-type printing unit 01. In print operation involving the double-sided imprinting of a web of print substrate 08 (or web 08), which passes through the printing unit 01 from bottom to top in transport direction T, for example, the transfer cylinders 06; 07 of a blanket-to-blanket printing couple 13 are engaged against one another.

The forme cylinders 03; 04 can be embodied as plate cylinders and the transfer cylinders 06; 07 as rubber cylinders. In the case of the embodiment example described here, the transfer cylinders 06; 07 mutually form impression cylinders. In principle, the printing unit 01 could also be embodied as a satellite printing unit, wherein two or even four transfer cylinders can be engaged against one satellite cylinder over the web 08. In general, the printing unit 01 is preferably embodied as a printing unit 01 having a plurality of printing couples arranged one above the other, imprinting on the same web side, and/or has a web path comprising an intake at the bottom and an outlet at the top. The printing unit 01 can also be formed from stacked “subunits”, so as to form, for example, individual, stacked arch-type printing units 13, each with its own side frame sections.

Peripheral units (not shown in detail), particularly one inking unit and optionally one dampening unit, are assigned to each of the respective forme cylinders 03; 04.

For each cylinder pair comprising forme cylinder and transfer cylinder 03; 04; 06; 07, at least one of the cylinders 03; 04; 06; 07 is arranged so as to be movable in a direction with a component that is perpendicular to its longitudinal axis (i.e., in a radial direction) in correspondingly configured bearing devices 09; 11, such that it can be thrown onto or thrown off from a cylinder 03; 04; 06; 07 with which it interacts in the print-on position, by means of bearings 19, e.g., bearing means 19, which enable the positioning movement. The bearing 19 that enables the positioning movement can generally be a pivot bearing 19, particularly an eccentric bearing 19. Preferably, this is at least the transfer cylinder 06; 07 of the respective printing couple, with printing couple meaning, for example, the unit comprising forme cylinder and transfer cylinder, along with inking unit and optionally dampening unit and optionally other peripheral functional units assigned to this cylinder pair, which applies an ink to one side of the web. In the present blanket-to-blanket printing couple 13, at least one of the transfer cylinders 06; 07, but preferably both transfer cylinders 06; 07, of the arch-type printing unit 13 are mounted in the side frame 02; 12 so as to be movable by means of the bearing devices 11, assigned to them and formed correspondingly with bearing means 19 that enable the positioning movement, at least between a print-on position, in which said cylinders are thrown onto the web of print substrate 08 or onto the respectively opposite transfer cylinders 06; 07, and a print-off position, in which these are thrown off from the web of print substrate 08 or the respectively opposite transfer cylinders 07; 06.

In the case of a preferred embodiment of the invention, all forme cylinders 03; 04 of the printing unit 01, e.g., H-type printing unit 01, are arranged in the bearing devices 09 assigned to them, fixed with respect to their respective radial positions in relation to the side frame 02; 12, i.e., no type of throw on/throw off mechanism for the forme cylinder 03; 04 in a radial direction, perpendicular to the axis of said cylinder, is provided (with the exception of optional adjustment means for alignment purposes), whereas, for example, all transfer cylinders 06; 07 are arranged so as to be radially adjustable in terms of their axial position, i.e., in the correspondingly formed bearing means 19 that enable the positioning movement, for example, bearing devices 11 comprising a pivot bearing 19, preferably an eccentric bearing 19, are mounted so as to be adjustable in a radial direction.

One preferred embodiment of an end-face bearing device 09; 11 which accommodates at least the rotational movement of the assigned cylinder 03; 04; 06; 07 is described in what follows in reference to an advantageous embodiment, which, in the case of a cylinder 03; 04; 06; 07 to be adjusted radially in the manner described above, also comprises the bearing means 19 that enable the positioning movement.

A bearing device 09; 11 is assigned to each end face of each cylinder 03; 04; 06; 07, by means of which bearing device a journal 14; 16 of the relevant cylinder 03; 04; 06; 07 is accommodated so as to rotate in relation to the bearing parts that are fixed to the frame. For this purpose, the bearing device 09; 11 has a bearing 17 that accommodates the journal 14; 16, for example, a radial bearing 17, e.g., a radial bearing 17 embodied as a roller bearing 17, which is accommodated indirectly or directly by an outer ring 23, e.g., outer bearing ring 23 or outer ring 23. The bearing device 09; 11 is arranged in a particularly circular opening 18, e.g., bore hole 18, in the side frame 02; 12. More particularly, a separate bearing device 09; 11 is assigned to each end face of each cylinder 03; 04; 06; 07, more particularly, is installed in a separate bore hole 18 in the side frame 02; 12. For a custom-fit and/or play-free arrangement of the bearing device 09; 11 in the side frame 02; 12, in the mounted state, a (particularly cylindrical) outer circumferential surface 21 of the bearing device 09; 11 interacts with the (particularly cylindrical) inner circumferential surface 22 of the bore hole 18. If the side frame 02; 12 is produced as a cast piece, the inner circumferential surface 22 is preferably surface-machined, e.g., using a CNC milling machine of high precision with respect to roundness and/or smooth and grade-free surfaces. The inner circumferential surface 22 of the bore hole 18 and the outer circumferential surface 21 of the outer ring 23 (optionally multiple parts radially in the area of the frame alignment) form a custom fit.

One possibility for a custom-fit and/or play-free installation of the bearing device 09; 11 in the side frames 02; 12 involves exploiting thermal effects, for example, in which, for example, the bearing device 09; 11 or a part of the bearing, e.g., an outermost ring 23 (e.g., outer ring 23 described below) of the bearing device 09; 11 to be installed, is produced with precisely the same diameter or with slightly larger dimensions than those of the bore hole, and is then cooled to below room temperature (shrunk to fit), and finally is inserted in this state into the bore hole 18. Heating (or allowing to heat) to ambient or room temperature causes the bearing device 09; 11 (or its outermost ring 23) to be fastened without play, or in the case of larger dimensions, under stress, in the bore hole 18. To support a disassembly and/or an intended rotation of the outer ring 23 in the bore hole 18, oil ducts can preferably open into the area of support between bore hole 18 and outermost ring 23, thereby facilitating an intended relative motion, for example, by applying high oil pressure. In an embodiment not shown here, the outer ring 23 can also be arranged without being shrunk to fit in the bore hole 18, with or without fitting in the bore hole 18, wherein the outer ring 23 can then be securely attached to the exterior of the frame by means of screws, for example, via a collar-shaped flange.

The bearing device 09; 11 has an external ring 23, e.g., outer ring 23, more particularly, bearing outer ring 23, which indirectly or directly accommodates the radial bearing 17. In an alternative embodiment, this outer ring 23 can be encompassed in the area of the frame alignment by an additional ring, to which it is connected, for example, non-rotatably and without play, wherein this outer ring then interacts as a support, without play, for example, with the wall of the bore hole 18 in the described manner. In this embodiment, the outer ring 23 is embodied as comprising multiple parts in terms of its radial construction, wherein the description in what follows is to be applied to this embodiment. In the radially multi-part embodiment of the outer ring 23, for example, the fastening to the side frame 02; 12 can be provided, for example, by means of the outer part of the multi-part outer ring 23, and the arrangement of bearing surfaces of a pivot or radial bearing can be provided in the inner part of the multi-part outer ring 23. However, the embodiment of the outer ring 23 is particularly installation space-saving and therefore particularly preferable in that it interacts on an outer surface, e.g., the outer circumferential surface 21, with the frame bore hole, e.g., the bore hole 18, while simultaneously providing a sliding or rolling surface for a pivot bearing or radial bearing on an inner surface (see below).

For fastening the outer ring 23, a ring 29 in the manner of a collar 29, which is supported on the outer frame side 02.2; 12.2 and is to be arranged, e.g., substantially coaxially to the bore hole 18, is provided, which can be produced as integral with the outer ring 23, or can be connected in a non-positive connection thereto, e.g., by welding, or by means of screws 28, as illustrated. This ring 29 is or can be detachably connected, for example, by means of screws 37, to the side frame 02; 12, particularly to the exterior frame side 02.2; 12.2. In this manner, the bearing device 09; 11 inserted into the bore hole 18 can be secured. In the case of a multi-part outer ring 23, the screw connection can be produced between collar 29 and outer ring 23 in the outer ring part.

The outer ring 23 is therefore a component of a mounting device that directly or indirectly supports the roller bearing 17, or conversely, the rings 23 of the bearing device 09; 11, particularly the bearing outer ring 23, simultaneously form a part of a mounting device, which in an integral embodiment fits directly in the opening 18, and optionally is or will be additionally secured by means of screws 37 and a collar 29.

This is also understood to involve a multi-part embodiment of the bearing outer ring 23, wherein this multi-part “bearing outer ring” 23 can then comprise a plurality of parts that are securely connected to one another, for example, in an axial direction. For example, a part 32 that indirectly or directly supports the radial bearing 17 and projects out of the frame alignment is securely, but optionally detachably, connected, for example, screwed, to a part to be arranged in the frame alignment (e.g., in the manner of an extension).

In an advantageous and illustrated embodiment, the radial bearing 17 is supported indirectly or directly on the inner circumference of a part 32 of a correspondingly extended outer ring 23, which part projects out of the frame alignment toward the cylinder 03; 04; 06; 07. This part 32 that projects out of the frame alignment and indirectly or directly supports the radial bearing 17 can be a section of an integral outer ring 23, formed as correspondingly longer (as illustrated), or, as was already described above, can be a part 32 of an outer ring 23 that comprises multiple parts in the axial direction (i.e., securely connected parts).

In the embodiment of the bearing device 09 for a cylinder 03; 04; 06; 07, which need not be or is not mounted so as to be thrown on/thrown off in the radial direction, the radial bearing 17 or the outer bearing ring thereof is directly and/or indirectly held and supported on a part 32 of the outer ring 23 that projects out of the frame alignment, particularly directly or via a spacer ring by the inner circumference of the part 32 of the outer ring 23 that projects out of the frame alignment; i.e., it lies outside of the frame alignment on the side of the side frame 02; 12 that is closer to the cylinder 03; 04; 06; 07. The inner running area of the radial bearing 17 is provided on the outer circumference of an inner ring 27, the inner circumference of which accommodates the journal 14; 16.

With the advantageous presence of a plurality of radial bearings 17, side by side as viewed in the axial direction, which support the journal 14; 16, or one radial bearing 17 with a plurality of circumferential tracks for rolling elements 36 (in the illustrated example, tracks for two) spaced axially from one another, at least one of the radial bearings 17 or at least one rolling element track that is closest to the cylinder, a plurality or preferably even all, e.g., in this case both, radial bearings 17 or tracks are advantageously arranged in an area of the bearing device 09; 11 or of the ring 23 that lies outside of the frame alignment (see, e.g., bearing device 09 of a forme cylinder 03; 04 in FIG. 4).

In this embodiment of the bearing device 09; 11, a particularly rigid and play-free mounting of the relevant cylinder 03; 04; 06; 07 is provided, which can be easily produced and can especially be assembled on site in a simple manner. With the arrangement of the radial bearing 17 or bearings moved toward the inside, to begin with, high thermal stress in the opening is possible without affecting the roller bearing preload; moreover, a distance between the receiving point closest to the cylinder and the end face of the cylinder 03; 04; 06; 07 is shortened. Furthermore, thermally induced cross-sectional changes in the roller bearing 17 and optionally in components that are close to the roller bearing resulting from operation do not result in unallowable stresses in the bearing elements and increased wear and tear associated with this.

In a preferred further development of the bearing device 11 for a cylinder 03; 04; 06; 07, in this case, for example, a transfer cylinder 06; 07, which is to be or is mounted so as to be thrown on and/or thrown off in a radial direction, the bearing means 19 that enables the positioning movement, for example, a pivot bearing embodied as an eccentric bearing 19 having at least one eccentric ring 38, e.g., spacer ring 38, particularly eccentric ring 38, is arranged between the radial bearing 17 or between a set of radial bearings 17 or rolling element tracks that accommodate a plurality of the journals 14; 16 and the outer ring 23. The radial bearing 17 is (or the radial bearings 17 are) arranged with its (or their) rotational axis R eccentric (eccentricity e) relative to a pivot axis S of the ring 38 in the latter. More particularly, the radial bearing 17 is or the radial bearings 17 are indirectly or directly arranged in an eccentrically disposed opening in the ring 38. In this case the measurement of eccentricity e (“adjustment eccentric”) ranges, e.g., from 10 to 25 mm, advantageously from 12 to 20 mm. The spacer ring 38 is arranged between the radial bearing 17 and the outer ring 23, more particularly, the ring 23 that in this case is ultimately connected to the radial bearing 17 indirectly via the spacer ring 38. In the embodiment example illustrated, this is the outer ring 23 that projects out of the frame alignment toward the cylinder side. The eccentric ring 38 is pivotably mounted indirectly or directly on or in the ring 23 that supports this. For this purpose, between the mounting device, i.e., the relevant ring 23 and the eccentric ring 38, a bearing 39 is provided, which in a simpler embodiment can be a plain bearing, but in a more advantageous embodiment can be a roller bearing 39. The inner running area for the rolling element 41 of the eccentric bearing 19 or the roller bearings 39 thereof and the outer running area for the rolling element 36 of the radial bearing 17 can, in principle, be components of two separate rings, which are connected to one another, e.g., non-rotatably and without play. However, the embodiment of a triple ring bearing that comprises the radial bearing and the eccentric bearing 17; 19 is advantageous, wherein a center ring, in this case the eccentric ring 38, has on its outer circumference the running area of the eccentric bearing 19 or the roller bearing thereof 39, and on its inner circumference the running area of the radial bearing 17.

Preferably, one embodiment of the bearing device 11 that enables the positioning movement is such that the eccentric bearing 19 or the bearing race thereof that is closest to the cylinder is directly or indirectly held and supported on a part 32 of the outer ring 23 (or of a correspondingly axially extended, multi-part outer ring) that projects out of the frame alignment; i.e., it also lies outside of the frame alignment on the side of the side frame 02; 12 that is closer to the cylinder 03; 04; 06; 07. In one preferred embodiment, therefore, both the radial bearing 17 and the eccentric bearing 19 lie in an area of the mounting device 23, 24 outside of the frame alignment on the side that is closer to the cylinder.

Of particular advantage is the relative arrangement of radial bearing and eccentric bearing 17; 19 wherein the axial positions of eccentric bearing 19 and radial bearing 17 are chosen such that the support areas L17; L19 thereof, i.e., the axial longitudinal section L19, in which rolling elements 41 or sliding surfaces of the eccentric bearing 19 which absorb radial forces are provided, and the axial longitudinal section L17 in which rolling elements 36 of the radial bearing 17 that absorb radial forces are provided, at least intersect with the same plane, which is perpendicular to the axial direction. The support areas L17; 19 in this embodiment are not spaced from one another axially, and instead overlap at least with respect to their axial positions. For the embodiment of the bearing device 09 without pivot bearing 19, the support area L17 is formed by the rolling elements 36, which then roll off against a corresponding running area of the outer ring 23 (without spacer ring).

In one preferred embodiment, the outer ring 23 is embodied as integral in a radial direction on at least one section of the part 32 which projects out of the frame alignment on the cylinder side and comprises the support area L17; L19 on its inner side, i.e., said outer ring does not consist on an inner part that has the running area and/or sliding area and an outer part that holds and supports this inner part. In this case, an outer circumferential surface 34 of the outer ring 23 is formed at least in this longitudinal section L17; L19 by the same component which has the sliding surface or running area on its inner side. Between outer circumferential surface 34 and sliding area or running area there is no joint that connects two partial rings to one another, e.g., detachably. In this connection, the outer ring 23 is preferably embodied as radially integral or as a single piece over the entire area that projects out of the frame alignment on the cylinder side.

The inner circumferential surface of the inner ring 27 and the outer circumferential surface of the journal 14; 16 to be accommodated can be embodied as cylindrical in the longitudinal area of their interaction, wherein in this case a “shrinking to fit” and/or a screw connection and/or a clamping of the inner ring 27 onto the journal 14; 16 by means of a set of clamps and/or a custom fit that is taken into consideration during production by way of particularly small dimensional tolerances is necessary. This embodiment has advantages with respect to the possibility of a relative axial alignment between bearing 17 and cylinder 06; 07; 03; 04, without the risk of altering a preset and/or desired bearing tension.

In the embodiment illustrated here, the inner circumferential surface of the inner ring 27 and the outer circumferential surface of the journal 14; 16 to be accommodated are embodied as conical, complementary to one another, and are positioned in an axial position relative to one another, optionally using a catch ring 24, and are advantageously connected and/or secured against rotation by means of screws.

In a preferred but not mandatory embodiment of the printing unit 01 or of the blanket-to-blanket printing couple 13, at least the bearing devices 09; 11 of one of a plurality of cylinders 03; 04; 06; 07, in this case, for example, the bearing devices 11 of the pivotable cylinder 06, is embodied with an alignment device, and is therefore additionally supported for alignment purposes, e.g., eccentrically, in the bore hole 18 of the side frame 02; 12 in such a way that when the outer ring 23 is rotated, the center of the inner cross-section that indirectly or directly accommodates the radial bearing 17 moves with at least a radial component (“alignment eccentric”). In this case, an eccentricity e′ can range from 1.5 to 8 mm, particularly from 2 to 5 mm. If the bearing device 11 is embodied with pivot bearing 19, this alignment eccentric is additionally provided for the pivot bearing 19, in this case the pivot eccentric. In the case of a bearing device 09 embodied without pivot bearing, this represents, e.g., the sole option for moving the rotational axis R in a direction with a radial component. In the case of a blanket-to-blanket printing couple 13 having four interacting cylinders 03; 0; 04; 07, at least one of the transfer cylinders 06; 07 and at least the other transfer cylinder 07; 06 or the forme cylinder 03; 04 assigned thereto is preferably embodied in the described manner with an alignment eccentric. If, in one embodiment of the printing unit 01, a satellite cylinder interacts with two forme/transfer cylinder pairs or with four forme/transfer cylinder pairs, then each of the transfer cylinders is advantageously embodied with an alignment eccentric. The “alignment device” that acts in relation to a radial installation position is understood as a device that differs from the adjustment device (pivot bearing 19 with drive) that acts in relation to the radial print-on/print-off position such that an adjustment is carried out operationally, but an alignment is carried out only for assembly or maintenance purposes.

In the present example, the alignment eccentric can be formed in that the center of the inner cross-section that indirectly or directly accommodates the radial bearing 17 does not coincide with the center Z of the bore hole 18, and is instead spaced therefrom by the eccentricity e′. This can be accomplished, for example, in that the center Z of the circular running area, which interacts with the rolling elements 41 (pivotable embodiment of the bearing 19) or 36 (non-pivotable embodiment of the bearing 17), is arranged on the inner circumference of the outer ring 23 eccentrically to the outer circumferential surface 21 of the bearing device 09; 11 or of the outer ring 23, which interacts with the inner circumferential surface 22 of the bore hole 18. For example, either the outer ring 23 is embodied as having a correspondingly variable wall thickness, or the running area is incorporated appropriately eccentrically in the inner circumference of the outer ring 23. Alignment can then be carried out, for example, during assembly of the printing unit 01 or for subsequent correction by rotating the outer ring 23 appropriately in the bore hole 18. Rotation can be carried out using an auxiliary mechanism, not shown, optionally using oil pressure as described above.

An embodiment of the bearing device 09; 11 illustrated in FIGS. 5 to 8 differs from the above-described embodiments only in that the bearing device 09; 11 does not need to be securely installed in the frame bore hole by means of thermal displacement as a result of cooling and heating, and can instead be secured in the bore hole in that the outer ring 23 interacts in an area of the frame alignment with a ring 61, e.g., clamping ring 61, wherein outer ring 23 and clamping ring 61 interact with mutually opposing surfaces in the manner of a set of clamping rings. In principle, the clamping ring 61 can encompass the bearing outer ring 23 or vice versa, as described in what follows. The surfaces that act as clamps in this case extend at an angle relative to the center axis of the bearing outer ring 23.

In this case, the inner surface of the outer ring 23 and the outer surface of the clamping ring 61 each have a conically extending, annular section 62; 63 (particularly ring section 62; 63), these being particularly complementary in terms of shape, such that an axially parallel relative movement of the two rings 23; 61 (in at least one relative direction) causes an at least slight widening of the outer ring 23. More particularly, this is caused by a relative movement of the rings 23; 61 in the direction in which the conically extending sections 62; 63 are brought closer to one another and therefore further overlapping one another or “wedged” with one another. Of course, the widening of the outer ring 23, and therefore the enlargement of the outer diameter of the outer ring 23, can be associated with a slight decrease in the inner diameter of the clamping ring 61. Outer ring and clamping ring 23; 61 have the corresponding conical ring sections 62; 63, but at least each has an interacting part of these ring sections 62; 63, viewed in the axial direction, such that in the assembled state, said sections or at least active parts of these sections 62; 63 come to rest or lie in the frame alignment, i.e., in the area between an alignment of the interior frame side 02.1; 12.1 and the alignment of the exterior frame side 02.2; 12.2 of the relevant side frame 02; 12, or at least of the part of the side frame 02; 12 that directly borders the opening 18.

The two rings 23; 61 can be moved toward one another or into one another in the manner described above, depending upon the arrangement, by way of tension means 28 (or as pressure means, not shown), preferably embodied as screws 28, particularly tightening screws. For this purpose, in the case of a screw 28 acting as tension means 28, the screw head is supported with its shoulder against a collar 29 that is secured to the frame, e.g., to the exterior frame side, or against a ring 29 that is in turn supported against a frame side 02.1; 02.2; 12.1; 12.2, particularly the exterior frame side 02.2; 12.2, and is, for example, to be arranged coaxially to the bore hole 18, and then extends through the collar 29 or the ring 29 in a bore hole, in which the screw 28 “rotates freely”, and interacts in a positive connection, for example, with a threading in an end face bore hole 31 in one of the rings 23; 61, e.g., the outer ring 23. In the case of a supporting ring 29, said ring is detachably connected, for example, e.g., by means of screws 37, to the side frame 02; 12, particularly to the exterior frame side 02.2; 12.2 (see, e.g., FIG. 7).

The tension means 28 preferably interacts with the ring 23; 61, with the ring wall cross-section becoming larger in the area of the conical ring section 62; 63 as the distance thereof from the screw 28 or from the supporting collar or ring 29 increases. In the embodiment, e.g., of the screw 28 or some other means for exerting pressure, in the case of a pressure means, the latter applies inversely, for example.

The other ring 61, i.e., the ring 61 that is different from the ring 23 that is moved relatively by the tension means 28, is supported indirectly or directly, for example, against a stop 33 that is secured to the frame on the same end face as the bore hole 31 of the first ring 23, against being moved along axially. The stop 33 can preferably be a part of the above-described collar 29 or ring 29, which is configured in a corresponding width. For alignment purposes, in one advantageous embodiment it can be expedient to arrange a register element 64, e.g., a single- or multiple-part register ring 64, between the relevant end face and the stop 33 secured to the frame. For this purpose, the diameter of the bore hole 18, the outer diameter and inner diameter of the outer ring 23, and the outer diameter of the clamping ring 61, along with the axial positions of the interacting conical sections 62; 63 and the length of the clamping ring 61, are to be configured or are configured in such a way that in the assembled state, a gap remains between stop 33 and the interacting end face of the clamping ring 61, which is fitted with a register ring 64 of specified thickness, depending upon the required preload. The ring 23 to be moved axially is then pulled by the screw(s) 28 against the collar 29 or ring 29, which is accompanied by greater or lesser widening, depending upon the thickness of the register ring 64, and by a resulting clamping force.

The two rings 23; 61 are therefore components of a mounting device that directly or indirectly supports the roller bearing 17, or inversely, one of the rings 23 of the bearing device 09; 11, particularly the bearing outer ring 23, forms a part of a mounting device which is clamped in the opening 18 by an interacting clamping ring 61. In principle, only one of the two interacting rings 23; 61 can also have a wedge-shaped or conically extending section 62; 63, which then causes a widening or compression of the same and/or the other ring 61; 23 with a corresponding relative movement. However, an embodiment of this type would be less stable with respect to tilting moments, so that advantageously, two circumferential surfaces extending complementary to one another over a significant section length, for example, at least 30 mm, particularly at least 50 mm, interact substantially flat with one another.

One of the two rings 23; 61 to be clamped against one another by way of an axial relative movement represents the bearing outer ring 23 that indirectly or directly accommodates the radial bearing 17. This is also meant to involve a multi-part embodiment of the bearing outer ring 23, wherein this multi-part “bearing outer ring” 23 can then comprise a plurality of parts securely connected to one another, for example, in an axial direction. For example, a part that indirectly or directly supports the radial bearing 17 is securely, but optionally detachably, connected, e.g., screwed, to a part that comprises the section 62 (e.g., in the manner of an extension).

In principle, the bearing outer ring 23 could be positioned on the inside in relation to the clamp, i.e., encompassed by the clamping ring, and the radial bearing 17 can then be accommodated by the bearing outer ring 23, which is positioned on the inside in relation to the clamp, in the area of the frame alignment—but, for example, in a ring section that is spaced axially from the conical section 63. However, in one advantageous alternative, to avoid undesirable stress in the radial bearing 17 the radial bearing 17 can be supported against the inner circumference of a part, which projects out of the frame alignment toward the cylinder 03; 04; 06; 07, of the correspondingly extended bearing outer ring 23, which is positioned on the inside in relation to the clamp.

In an advantageous and illustrated embodiment, the radial bearing 17 is indirectly or directly supported on the inner circumference of the part 32, which in this embodiment also projects out of the frame alignment toward the cylinder 03; 04; 06; 07, of a correspondingly extended outer ring 23, which with respect to the clamp, encompasses the clamping ring 61, i.e., is arranged on the outside in relation to the clamp. This part 32, which projects out of the frame alignment and indirectly or directly supports the radial bearing 17, can, as in the first embodiment, be a section of an integral outer ring 23 (as shown) of correspondingly greater length; or as was already described above, can be a part 32 of an outer ring 23 that has multiple parts in the axial direction, for example (i.e., securely connected parts).

In the embodiment of the bearing device 09 for a cylinder 03; 04; 06; 07, which does not need to be or is not mounted so as to be adjusted in the above-described manner, the radial bearing 17 or the outer bearing ring thereof, as described in reference to the first embodiment example, is directly or indirectly accommodated and supported against a part 32 of the outer ring 23 that projects out of the frame alignment, particularly directly or via a spacer ring by the inner circumference of the part 32 of the outer ring 23 that projects out of the frame alignment; i.e., it lies outside of the frame alignment on the side of the side frame 02; 12 that is closer to the cylinder 03; 04; 06; 07. The inner running area of the radial bearing 17 is provided on the outer circumference of an inner ring 27, the inner circumference of which accommodates the journal 14; 16.

In the case of a plurality of radial bearings 17, side by side as viewed in the axial direction, which accommodate the journal 14; 16, or one radial bearing 17 having a plurality of circumferential tracks for rolling elements 36 spaced axially from one another (in the represented example, tracks for two), the above-described is also to be applied.

In this second embodiment of the bearing device 09; 11, a particularly rigid and play-free mounting of the relevant cylinder 03; 04; 06; 07 is also accomplished, which can be easily produced and can especially be easily assembled on site. Even after being finished, its rigidity can still be adjusted, and it can be dismantled without being destroyed. As a result of the arrangement of the radial bearings 17 or bearing 17 moved toward the inside, as with the first embodiment, clamping in the side frame 02; 12 is possible without affecting the roller bearing preload, and secondly, the distance of the receiving point closest to the cylinder from the end face of the cylinder 03; 04; 06; 07 is shortened. Thirdly, in this case as well, thermally induced cross-sectional changes to the roller bearing 17 and optionally to components close to the roller bearing, resulting from operation, do not result in any unallowable stresses in the bearing elements.

As has already been described in reference to the first embodiment example, in a preferred further development of the bearing device 11 for a cylinder 03; 04; 06; 07, for example, a transfer cylinder 06; 07, which is to be or is mounted so as to be adjustable in the manner described above, in this case as well, the bearing means 19 that enables the positioning movement, e.g., the eccentric bearing 19 with at least one eccentric ring 38, e.g., spacer ring 38, particularly eccentric ring 38, is arranged between the radial bearing 17 or between the set of multiple radial bearings 17 that accommodate the journal 14; 16 or rolling element tracks and the side frame 02; 12. The radial bearing 17 is (or the radial bearings 17 are) arranged with its (or their) rotational axis R again eccentric (eccentricity e) in relation to the pivoting axis S of the ring 38 in the latter. For implementing and/or arranging the eccentric bearing 19 in the outer ring 23, the description related to the first embodiment is to be applied. The same is true of the optional use of an alignment eccentric having an eccentricity e′, not illustrated here. Also of particular advantage in this case is an embodiment of the bearing device 11 that enables the positioning movement in such a way that the eccentric bearing 19 or the bearing ring thereof that is closest to the cylinder is accommodated and supported directly or indirectly on a part 32 of that of the outer ring 23 (or of the correspondingly extended, multi-part outer ring) which projects out of the frame alignment; i.e., it also lies outside of the frame alignment on the side of the side frame 02; 12 that is closer to the cylinder 03; 04; 06; 07. In a preferred embodiment, therefore, both the radial bearing 17 and the eccentric bearing 19 lie in an area of the mounting device 23, 61 outside of the frame alignment on the side that is closer to the cylinder. The above description relating to the relative arrangement and the axial relative position of radial bearing and eccentric bearing 17; 19 is also to be applied similarly here.

For the specified embodiments, the bearing means 19 that enable the positioning movement of the adjustable cylinder 06; 07 (03; 04), together with a drive means 42 that accomplishes the positioning movement, are each a component of an adjustment device. If the bearing means 19 that enables the positioning movement is embodied as an eccentric bearing 19, a rotation of the eccentric ring 38 by the drive means 42 is necessary for the adjustment. The following description is to be applied similarly to the above-described embodiments.

In one advantageous embodiment, the eccentric ring 38 is articulated via, e.g., a joint 43 (indicated by a dashed line in FIGS. 2 and 5) by means of a push and/or pull element 44, e.g., a connecting rod 44. The articulation is preferably implemented on the interior frame side 02.1; 12.1. In principle, the connecting rod 44 can be an extension of a piston or cylinder of a cylinder/piston system (pneumatic or hydraulic cylinder), which is also arranged articulated on the side frame 02; 12 (e.g., the interior side). However, advantageous with respect to installation space is the described embodiment in which the connecting rod 44 is articulated at its end that is remote from the eccentric to a lever 46, which is in turn pivotable via a shaft 47 that projects through the side frame 02; 12 parallel with the cylinder (see, e.g., FIGS. 9 and 10). As a drive means 42 that pivots the shaft 47, in this case, in principle, a drive motor arranged on the exterior frame side 02.2; 12.2 can be provided. In the described embodiment, however, on the exterior frame side 02.2; 12.2 a pressure medium actuable, particularly pneumatically or hydraulically actuable, cylinder/piston system 42 is provided, which is articulated, e.g., via a push and/or pull element 48, e.g., connecting rod 48, to a lever 49 arranged on the shaft 47, and on the other side, is articulated to the side frame 02; 12 on the exterior frame side 02.2; 12.2. When the cylinder/piston system 42 is acted on by pressure medium, the shaft 47 is pivoted via the connecting rod 48, and the rotational movement thereof is transmitted via the lever 46 and the connecting rod 44 as a pivoting of the eccentric ring 38. In order to ensure a defined and/or definable position of adjustment of the cylinder 06; 07, in one advantageous embodiment, a stop 51 that limits the pivoting movement in the print-on direction can be provided. This is preferably embodied as adjustable. This adjustment drive can in a mirror image on both end faces of the cylinder 03; 04; 06; 07, i.e., for each interior side, at least the articulation of the eccentric ring 38 via the joint 43, a connecting rod 44, a lever 46 and a shaft 47.

In an advantageous further development, the shaft 47 is embodied as continuous across the inside width between the two side frames 02; 12, such that the two levers 46 that are in active connection with the two end face eccentric bearings 38 of the same cylinder 06; 07 engage on the same shaft 47, thereby resulting in a synchronous positioning movement. In this case, although the shaft 47 can be driven on both sides, each via drive means 42 on the exterior wall side, e.g., each in the manner described above, for reasons of installation space and/or cost, a solution is advantageous in which on only one side I; II, particularly on a side I that is opposite the drive side II (see below), the shaft 47 is driven, e.g., from the exterior frame side 12.2.

Preferably, each cylinder 03; 04; 06; 07 of a printing couple comprising a transfer cylinder and a forme cylinder 03; 04; 06; 07, or the four cylinders 03; 04; 06; 07; of a blanket-to-blanket printing couple 13, is provided with its own bearing device 09; 11—with or without a throw on/throw off mechanism—, each of which is provided in its own opening 18 and is preloaded. Between the openings 18, at least connecting members 52 of the relevant side frame 02; 12 are held in place, so that the bearing devices 09; 11 can be clamped independently of one another, without play and without affecting one another.

End-face bearing devices 09 without bearing means 19 that enable the positioning movement are assigned to (each of) the forme cylinders 03; 04, and end-face bearing devices 11 with bearing means 19 that enable the positioning movement are assigned to (each of) the transfer cylinders 06; 07 (e.g., FIGS. 4 and 8). On one side II, a so-called drive side II, the cylinders 03; 04; 06; 07 can be rotationally driven and/or are positively driven. In this case, in principle, each cylinder 03; 04; 06; 07 can be provided with its own drive motor 53, or each blanket-to-blanket printing couple 13 can be provided with a drive motor 53 that drives the four cylinders 03; 04; 06; 07 via a gear train, or advantageously, for each forme cylinder and transfer cylinder 03; 04; 06; 07 pair, a drive motor 53 (for production operation) can be provided (schematically illustrated by way of example in FIGS. 4 and 8). In the embodiment example illustrated, the drive is implemented by the drive motor 53 via a pinion gear 54 on a toothed gear 56, e.g., spur gear 56, which is non-rotatably connected to the journal 14 of the forme cylinder 03; 04, and by said spur gear on a toothed gear 57, e.g., spur gear 57, which is connected to the journal 16 of the assigned transfer cylinder 06; 07. In this case, in addition to the spur gear 57, a second toothed gear 58, a so-called backlash gear 58, can be connected to the journal 16 and, for example, rotated slightly in relation to the spur gear 57, as a result of which a change in tooth profile under minor load variations, for example, can be avoided. In an advantageous variant of the embodiment, not shown here, the drive can also be implemented by the drive motor 53 via a pinion gear or directly axially (optionally via an angle and/or offset compensating coupling) on the journal 16 of the transfer cylinder 07; 08 of the respective pair, in which case, e.g., the backlash gear 58 can be dispensed with. In the stated variants, in one embodiment, the forme cylinder 03 can further drive an inking unit, not shown here, assigned to each forme cylinder 03; 04. This is embodied, for example, as a roller inking unit having at least one ink source, e.g., ink fountain, doctor blade bar or metering strip, with at least one inking roller for transferring ink coming from the ink source to at least one oscillating distribution cylinder, and with at least one forme roller for transferring ink coming from the distribution cylinder to the forme cylinder. In this case, however, in one advantageous embodiment at least one of the rollers, particularly at least one distribution cylinder, can be positively driven or is positively driven during production operation by a drive motor that is mechanically independent of the drives of the cylinders 03; 04; 06; 07. If the inking unit is embodied as an anilox inking unit with at least one doctor blade device, one screen roller and at least one forme roller, then at least the screen roller can preferably be positively driven and/or is positively driven during production operation by a drive motor, which is mechanically independent of the drives of the cylinders 03; 04; 06; 07.

In the case of wet offset, for each forme cylinder 03; 04, a dampening unit, not shown, comprising at least two rollers is provided. At least one of these rollers, particularly a roller embodied as an oscillating distribution cylinder, can be positively driven and/or is positively driven during production operation by a drive motor that is mechanically independent of the drives of the cylinders 03; 04; 06; 07.

On the side I that is opposite the drive side II, for example, an axial drive 59, e.g., lateral register drive 59, not specified in greater detail, is advantageously provided for each forme cylinder 03; 04, by means of which drive the axial position of the forme cylinder 03; 04 can be adjusted. The radial bearings 17 of the forme cylinder 03; 04 are embodied with a degree of play in the axial direction according to the desired adjustment path, i.e., enabling an axial relative movement between the running area that is fixed to the journal and the running area that is fixed to the frame for the rolling elements 36 of the radial bearing 17. For axial disconnection between axial drive and journal 14, an axial bearing 26 is preferably provided, which absorbs axial forces but ensures relative rotary motion.

### LIST OF REFERENCE SIGNS

01 Printing unit, H-type printing unit
02 Side frame
03 Cylinder, printing couple cylinder, forme cylinder
04 Cylinder, printing couple cylinder, forme cylinder
05 —
06 Cylinder, printing couple cylinder, transfer cylinder
07 Cylinder, printing couple cylinder, transfer cylinder
08 Web of print substrate, web
09 Bearing device
10 —
11 Bearing device
12 Side frame
13 Blanket-to-blanket printing couple, arch-type printing unit,
14 Journal
15 —
16 Journal
   17 Bearing, radial bearing, roller bearing
18 Opening, bore hole
19 Bearing, bearing means, pivot bearing, eccentric bearing
20 —
21 Outer circumferential surface (09; 11)
22 Inner circumferential surface (18)
23 Ring, bearing ring, outer ring, bearing outer ring
24 Catch ring
25 —
26 Axial bearing
27 Inner ring
28 Tension means, screw
29 Ring, collar
30 —
31 Bore hole
32 Part or extension of the outer ring (23)
33 Stop
   34 Outer circumferential surface (23; 32)
35 —
36 Rolling element
   37 Screw
   38 Ring, eccentric, spacer ring, eccentric ring
39 Bearing, roller bearing
40 —
41 Rolling element
42 Drive means, cylinder/piston system, pressure actuable
43 Joint
44 Push and/or pull element, connecting rod
45 —
46 Lever
47 Shaft
48 Push and/or pull element, connecting rod
49 Lever
50 —
51 Stop
52 Connecting member (02; 12)
53 Drive motor
54 Pinion gear
55 —
56 Toothed gear, spur gear
57 Toothed gear, spur gear
58 Toothed gear, backlash gear
59 Axial drive, lateral register drive
60 —
61 Ring, clamping ring
62 Section, ring section (23)
63 Section, ring section (23)
64 Register element, register ring
02.1 Frame side, interior
02.2 Frame side, exterior
e Eccentricity
e′ Eccentricity
L17 Support area, longitudinal section (17)
L19 Support area, longitudinal section (19)
R Axis of rotation
S Pivot axis
T Transport direction
Z Center (18)
I Side
II Side, drive side

1-17. (canceled)

18. A printing unit (01) of a printing press with end-face side frames (02; 12) and a device for mounting a cylinder (03; 04; 06; 07) on the side frames (02; 12) in bearing devices (09; 11), wherein for the bearing device (09; 11) an inner ring (27) of a radial bearing (17) for accommodating a journal (14) of the cylinder (03; 04; 06; 07) is provided, and is indirectly arranged in an outer ring (23) via a bearing means (19) that enables a radial movement of the journal (14), wherein the outer ring (23) is in turn indirectly or directly mounted in an opening (18) in the side frame (02; 12), and wherein the radial bearing (17), viewed in the axial direction, is arranged in an area of the outer ring (23) which projects out of a frame alignment of the side frame (02; 12) toward the side of the cylinder (03; 04; 06; 07), and wherein the bearing means (19) that enables the radial movement of the cylinder (03; 04; 06; 07) is also arranged in an area of the outer ring (23) that projects out of a frame alignment of the side frame (02; 12) toward the side of the cylinder (03; 04; 06; 07), characterized in that the opening (18) in the side frame (02; 12) is embodied as a circular opening (18) and in that an alignment device is provided, in which a straight line that extends axially through the center of the inner circumference of the outer ring (23), which indirectly accommodates the radial bearing (17), extends spaced by an eccentricity (e′) from a straight line that extends axially through the center (Z) of the circular opening (18).

19. The printing unit according to claim 18, characterized in that the axial positions of the bearing means (19) that enables radial movement and of the radial bearing (17) are such that the support areas (L17; L19) thereof that absorb the radial forces intersect with the same plane, which is perpendicular to the axial direction of the radial bearing (17).

20. The printing unit according to claim 18, characterized in that the bearing means (19) that enables the radial movement of the journal (14) comprises a ring (38) arranged between outer ring (23) and radial bearing (17), with the radial bearing (17) being arranged eccentrically in relation to the outer circumference of said ring.

21. The printing unit according to claim 18, characterized in that the outer ring (23) is embodied as integral in a radial direction, at least over a section that corresponds to the longitudinal section (L17; L19) of the support area (L17; L19) assigned to the outer ring (23) from its inner side.

22. A printing unit of a printing press having end-face side frames (02; 12) and a device for mounting cylinders (03; 04; 06; 07) of a printing press in a side frame (02; 12) having at least four cylinders (03; 04; 06; 07) that interact directly or indirectly with one another, specifically two transfer cylinders (06; 07), each with one forme cylinder (03; 04) that interacts with the transfer cylinder (06; 07) in the print-on position, wherein at the end face of each cylinder (03; 04; 06; 07) of a printing couple of the printing unit (01), a bearing device (09; 11) is provided, with a bearing outer ring (23) which indirectly or directly accommodates a radial bearing (17), wherein the radial bearing (17) is arranged indirectly or directly in an area of the bearing outer ring (23) which projects out of a frame alignment of the side frame (02; 12) toward the side of the cylinder (03; 04; 06; 07), and wherein the end-face bearing devices (11) of at least a first of the two transfer cylinders (06; 07) has a bearing means (19) that enables the radial positioning movement of the cylinder (03; 04; 06; 07), which bearing means, viewed in the axial direction, is also arranged in an area of the bearing outer ring (23) which projects out of a frame alignment of the side frame (02; 12) toward the side of the cylinder (03; 04; 06; 07), characterized in that each of the bearing devices (09; 11) is mounted in a circular opening in the side frame (02; 12) that is assigned solely to the bearing device (09; 11) of the assigned cylinder (03; 04; 06; 07).

23. The printing unit according to claim 22, characterized in that the bearing devices (09; 11) assigned to at least one of the cylinders (03; 04; 06; 07) have an alignment device that acts in relation to a radial installation position.

24. The printing unit according to claim 22, characterized in that at least the first of the two transfer cylinders (06; 07) is mounted at both ends in the side frame (02; 12) by means of a device according to one or more of claims 1 to 4.

25. The printing unit according to claim 22, characterized in that the two transfer cylinders (06; 07) are arranged interacting in the print-on position, and the bearing devices (11) of both transfer cylinders (06; 07) have an alignment device according to claim 1.

26. The printing unit according to claim 22, characterized in that the two transfer cylinders (06; 07) are arranged interacting in the print-on position, wherein the bearing device (11) of the first transfer cylinder (06) has an alignment device according to claim 1, and the bearing device (11) of the forme cylinder (03; 04) assigned to the second transfer cylinder (07) has an alignment device, in which a straight line which extends axially through the center of the inner circumference of the outer ring (23) that accommodates the radial bearing (17) extends spaced by an eccentricity (e′) from a straight line that extends axially through the center (Z) of the opening (18).

27. The printing unit according to claim 22, characterized in that the two transfer cylinders (06; 07) are arranged interacting in the print-on position with a shared impression cylinder, and the bearing devices (11) of the two transfer cylinders (06; 07) have an alignment device according to claim 1 and/or a bearing means (19) that enables the radial positioning movement of the cylinder (03; 04; 06; 07).

28. The printing unit according to claim 22, characterized in that all, especially four, cylinders (03; 04; 06; 07) of a blanket-to-blanket printing couple (13) or all cylinders (03; 04; 06; 07) of a printing unit (01) have a bearing device (09; 11) at each end face, the radial bearing (17) of which, viewed in the axial direction, is arranged in an area of the outer ring (23) which projects out of a frame alignment of the side frame (02; 12) toward the side of the cylinder (03; 04; 06; 07).

29. The printing unit according to claim 18, characterized in that an eccentric ring (38) of the bearing means (19) embodied as an eccentric device (19) is articulated on the interior frame side (02.1) for the adjustment of said ring.

30. The printing unit according to claim 29, characterized in that a drive means (42) for adjusting the eccentric ring (38) is arranged on the side of the exterior frame side (02.2) and acts on the eccentric ring (38) via one or more transfer elements that extend through the side frame (02).

31. The printing unit according to claim 22, characterized in that for a blanket-to-blanket printing couple (13) comprising two forme cylinders and two transfer cylinders (03; 04; 06; 07), a shared, or for each pair comprising one as forme cylinder (03; 04) and one transfer cylinder (06; 07), at least one drive motor (53) that is mechanically independent of the remaining cylinders of the printing unit (01) is provided.

32. The printing unit according to claim 31, characterized in that for each forme cylinder and transfer cylinder (03; 04; 06; 07) a separate drive motor (53) is provided, said motors being mechanically independent of one another and of the remaining cylinders of the printing unit (01).

33. The printing unit according to claim 18, characterized in that the bearing outer ring (23) is arranged in an area of the frame alignment, interacting with a clamping ring (261) arranged coaxially thereto, wherein bearing outer ring (23) and clamping ring (61) are equipped in at least one section (62; 63) that lies in the area of the frame alignment with mutually opposing circumferential surfaces that extend conically in an axial direction, such that these are embodied as interacting in the manner of a set of clamping rings.
